(19) United States
(12) Patent Application Publication
(10) Pub. No.: US 2004/0107595 A1
(43) Pub. Date: Jun. 10, 2004

(54) Drier

(75) Inventors: Ichiro Kamimura, Gunma (JP); Tetsuya Masuda, Saitama (JP)

Correspondence Address: MCDERMOTT, WILL & EMERY, 600 13th Street, N.W., Washington, DC, 20005-3096, US

(73) Assignee: SANYO ELECTRIC CO., LTD.

(21) Appl. No.: 10/674,814

(22) Filed: Oct. 1, 2003

(30) Foreign Application Priority Data
Oct. 1, 2002 (JP) 288786/2002
Sep. 5, 2003 (JP) 314032/2003

(51) Int. Cl. F26B 19/00

(52) U.S. Cl. 34/218

(57) ABSTRACT

There is provided a drier which can shorten drying time of an article to be dried to greatly reduce the amount of energy consumption. A refrigerant circuit is disposed, which is constituted by sequentially installing and connecting a compressor, a gas cooler, an expansion valve and an evaporator in an annular shape. A blower is disposed, which circulates air in a drying chamber to exchange heat with the gas cooler and the evaporator. Moisture contained in the air which dries the article contained in the drying chamber is condensed to be discarded by the evaporator.

### BACKGROUND OF THE INVENTION

The present invention relates to a drier which comprises a drying chamber which contain an article to be dried.

Conventionally, a general drier similar to that described in Jpn. Pat. Appln. KOKAI Publication No. 2002-336594 has dried an article to be dried in a drying chamber by using an electric heater or a combustion heater as a heat source, heating outside air by the heat source of such an electric heater or a combustion heater to make it high-temperature air, and then blowing it into the drying chamber which contains the article to be dried. Then, the high-temperature air in the drying chamber which has dried the article to be dried is discharged to the outside.

However, in the drier which uses such an electric heater or a combustion heater, moisture-containing outside air in which a temperature outside the drying chamber is low is used for the high-temperature air sent into the drying chamber. It consequently takes a long timed for the article to be dried. Thus, the amount of energy consumption to dry the article is large, which creates a problem of a high rise in energy costs such as electricity bills or gas bills.

The high-temperature air which has dried the article is discharged indoors or outdoors outside the drying chamber. Thus, in the case of discharging the high-temperature air indoors, a temperature and humidity in a room in which the drier has been installed are increased to deteriorate an in-room environment. In the case of discharging the high-temperature air outdoors, an exhaust duct must be laid from the drier to the outdoors, which creates a problem of a high rise in equipment costs.

### SUMMARY OF THE INVENTION

The present invention has been developed to solve the problems of the prior art, and an object of the present invention is to provide a drier which can shorten drying time of an article to be dried to greatly reduce the amount of energy consumption.

A first aspect of the present invention is directed to a drier which is equipped with a drying chamber for containing an article to be dried, comprising a refrigerant circuit constituted by sequentially installing and connecting a compressor, a gas cooler, a pressure reducing device and an evaporator in an annular shape; and blowing means for circulating air in the drying chamber to exchange heat with the gas cooler and the evaporator.

A second aspect of the present invention is directed to the above drier, wherein a CO₂ refrigerant is sealed in the refrigerant circuit.

A third aspect of the present invention is directed to the above drier further comprising a rotary drum which is attached to a base through a suspension for vibration absorption and in which the drying chamber is installed, wherein components constituting the refrigerant circuit are attached to the base, the air heat-exchanged with the gas cooler is supplied into the drying chamber, and a duct member for introducing the air passed through the drying chamber into the evaporator is flexible.

### BRIEF DESCRIPTION OF THE DRAWINGS

FIG. 1 is a schematic constitutional view of a drier according to an embodiment of the present invention (first embodiment).

FIG. 2 is a longitudinal section side view of a rotary compressor which constitutes the drier of FIG. 1.

FIG. 3 is a conceptual view showing a compression step of a second rotary compression element of the rotary compressor of FIG. 2.

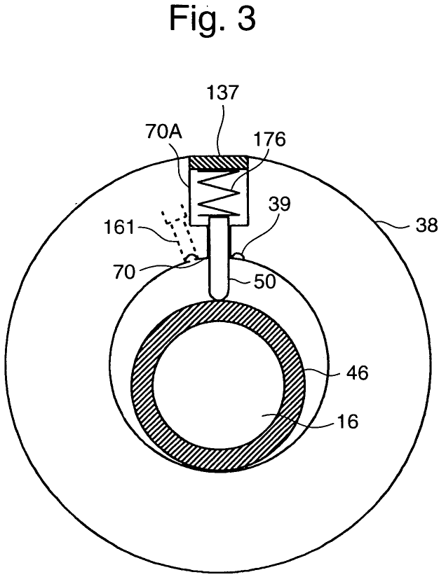

FIG. 4 is a refrigerant circuit diagram of the drier of FIG. 1.

FIG. 5 is a perspective view showing an internal constitution of a washing drier according to another embodiment of the present invention (second embodiment).

### DETAILED DESCRIPTION OF THE REFERRED EMBODIMENTS

Next, the preferred embodiments of the present invention will be described in detail with reference to the accompanying drawings.

(First Embodiment)

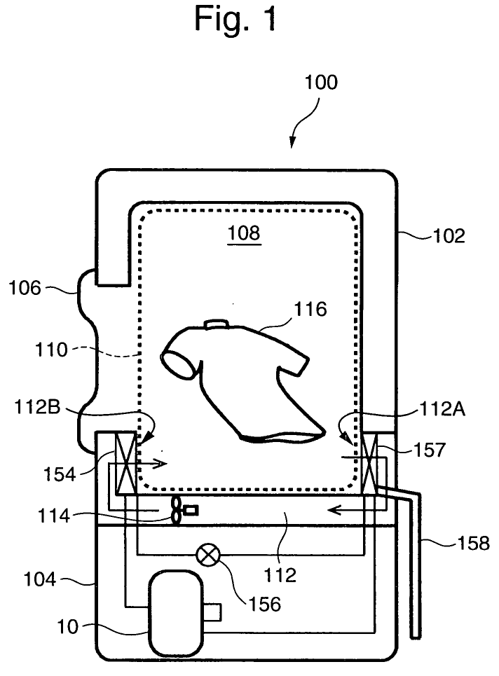

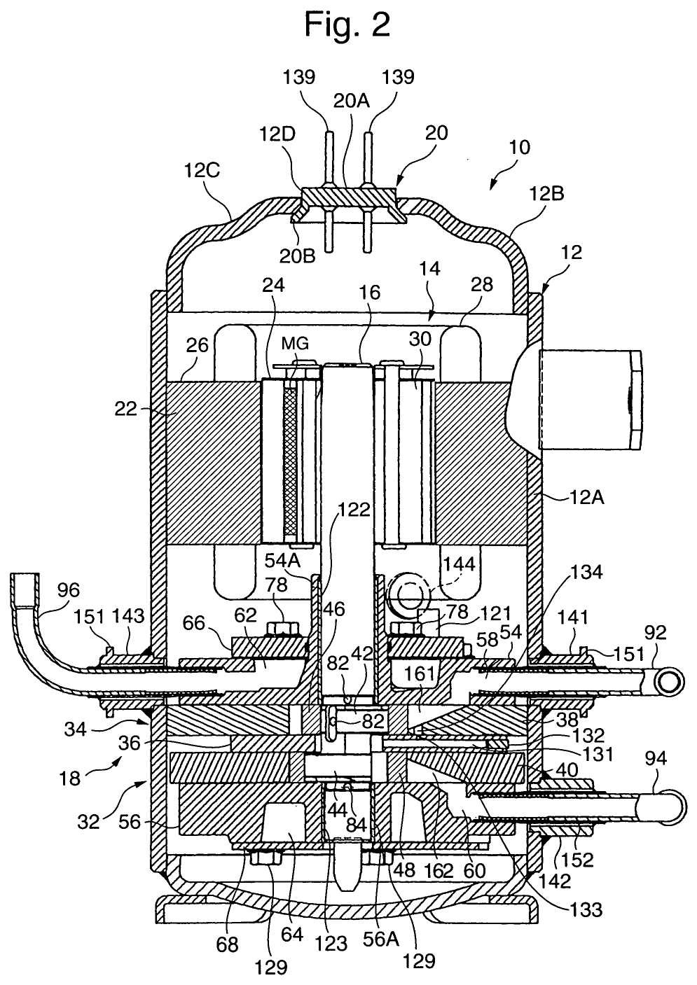

FIG. 1 is a schematic constitutional view of a drier 100 according to an embodiment of the present invention. FIG. 2 is a longitudinal section side view of a rotary compressor (compressor) 10 which constitutes the drier 100 of FIG. 1. The drier 100 is used to dry an article 116 to be dried, e.g., a laundry (clothes). The drier 100 comprises a main body 102 in an upper side of which a drying chamber 18 is disposed, and a machine chamber 104 disposed in a lower side of the main body 102. In the main body 102, a rotary drum 110 is disposed to efficiently dry the article 116 by rotating it. The rotary compressor 10 is disposed in the machine chamber 104. A hollow air circulation path 112 is disposed between the drying chamber 108 and the machine chamber 104 to communicate them with each other.

An inlet 112A is disposed on one side (right side in the drawing) of the air circulation path 112, and an outlet 112B 8 is disposed on the other side (left side in the drawing). The inlet 112A and the outlet 112B are communicated with the insides of the air circulation path 112 and the drying chamber 108. An evaporator 157 (dehumidifier) is installed on the inlet 112A side of the air circulation path 112, and a gas cooler 154 (heater) is installed on the outlet side. A blower 114 (equivalent to blowing means of the present invention) is installed between the inlet 112A and the outlet 112B of the air circulation path 112.

As indicated by arrows in FIG. 1, the blower 14 constitutes an air circulation in which air of the drying chamber 108 is sucked from the inlet 112A of the air circulation path 112, and sent through the evaporator 157 and the gas cooler 154 into the drying chamber 108 from the outlet 112B of the air circulation path 112. By circulating the air of the drying chamber 108 through the air circulation path 112 by the blower 114, the drier 100 supplies the air heated by gas cooler 54 into the drying chamber 108, dries the article 116 in the drying chamber 108, and then cools the air by the evaporator 157.

That is, a circulation is repeated in which the article 116 to be dried in the drying chamber 108 is dried by the air heated by the gas cooler 154, moisture contained in the dried air is condensed to be eliminated by the evaporator 157 of a low temperature, thereby setting a dehumidified state, and the dehumidified air is heated again by the gas cooler 154 to dry the article 116 in the drying chamber 108. A referent numeral 158 denotes a drain pipe to discharge water droplets condensed on the surface of the evaporator 157, and its tip is opened in, e.g., a drain ditch (not shown). A reference numeral 106 denotes an opening/closing door used when the article 116 to be dried is taken in or out of the drying chamber 108. It is attached to the front face of the drying chamber 108 of the main body 102 so as to be opened/closed.

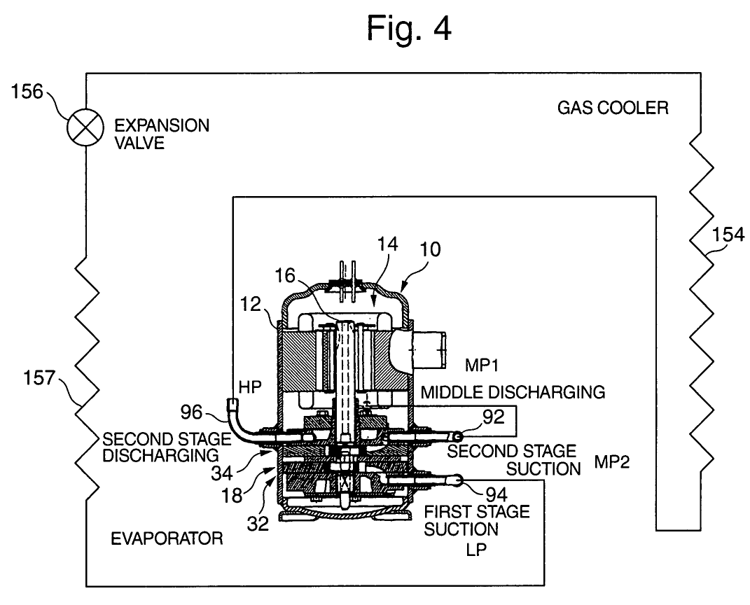

On the other hand, the rotary compressor 10, the evaporator 157, the expansion valve 156 and the gas cooler 154 are installed and connected in an annular shape to constitute a refrigerant circuit shown in FIG. 4. The rotary compressor 10 is an internal middle pressure multistage compression type which uses CO₂ as a refrigerant. This rotary compressor 10 comprises, as shown in FIG. 2, a cylindrical airtight container 12 made of a steel plate, an electric element 14 arranged on an upper side of internal space of the airtight container 12, and a rotary compression mechanism section 18 which is arranged below the electric element 14 and which is constituted of a first rotary compression element 32 (first stage) and a second rotary compression element 34 (second stage) driven by a rotary shaft 16 of the electric element 14.

According to the embodiment, a height dimension of the rotary compressor 10 is about 220 mm (outer diameter about 120 mm), a height dimension of the electric element 14 is about 80 mm (outer diameter about 110 mm), a height dimension of the rotary compression mechanism section 18 is about 70 mm (outer diameter about 110 mm), and an interval between the electric element 14 and the rotary compression mechanism section 18 is about 5 mm. Additionally, an elimination capacity of the second rotary compression element 34 is set smaller than that of the first rotary compression element 32.

According to the embodiment, the airtight container 12 is made of a steel plate of a thickness of about 4.5 mm, and a bottom portion is an oil reservoir. The airtight container 12 comprises a container main body 12A which contains the electric element 14 and the rotary compression mechanism section 18, and a roughly bowl-shaped end cap (cap body) 12B which closes an upper opening of the container main body 12A. A circular attaching hole 12D is formed on an upper surface center of the end cap 12B, and a terminal (wiring is omitted) 20-is fixed to the attaching hole 12D to supply power to the electric element 14.

In this case, a step 12C of a predetermined curvature is formed annularly on the end cap 12B around the terminal 20. The terminal 20 comprises a circular glass section 20A through which an electric terminal 139 is attached, and a metal attaching section 20B formed around the glass section 20A and bulged obliquely downward outside in a flange shape. A thickness dimension of the attaching section 20B is set to 2.4±0.5 mm. The terminal 290 is fixed to the end cap 12B by inserting the glass section 20A into the attaching hole 12D from the lower side to face the upper side, and welding the attaching section 290B to the peripheral edge of the attaching hole 12D of the end cap 12B in a state in which the attaching section 20B is abutted on the peripheral edge of the attaching hole 12D.

The electric element 14 comprises a stator 22 annularly attached along the inner peripheral surface of the upper space of the airtight container 12, and a rotor 24 inserted and arranged inside the stator 22 with a slight gap. The rotor 24 is fixed to a rotary shaft 16 extended through a center in a vertical direction.

The stator 22 has a laminated body 26 constituted by laminating doughnut-shaped electromagnetic steel plates, and a stator coil 28 wound on the tooth portion of the laminated body 26 by a series-winding (central-winding) method. As in the case of the stator 22, the rotor 24 is constituted of a laminated body 30 of electromagnetic steel plates, and a permanent magnet MG is inserted into the laminated body 30.

A middle partition plate 36 is held between the first rotary compression element 32 and the second rotary compression element 34. That is, the first rotary compression element 32 and the second rotary compression element 34 comprise the middle partition plate 36, cylinders 38, 40 arranged on and below the middle partition plate 36, upper and lower rollers 46, 48 fitted to upper and lower eccentric sections 42, 44 disposed in the rotary shaft 16 to be eccentrically rotated with a phase difference of 1800 in the upper and lower cylinders 38, 40, later-described upper and lower vanes 50 (lower vane is not shown) abutted on the upper and lower rollers 46, 48 to divide the insides of the upper and lower cylinders 38, 40 into low and high pressure chambers, and an upper supporting member 54 and a lower supporting member 56 as supporting members which close the upper opening surface of the upper cylinder 38 and the lower opening surface of the lower cylinder 40 to serve as bearings of the rotary shaft 16.

In the upper supporting member 54 and the lower supporting member 56, suction paths 58, 60 are formed to be communicated with the insides of the upper and lower cylinders 38, 40 through suction ports 161, 162, discharge sound-muffling chambers 62, 64 are formed to be recessed, and openings of the discharge sound-muffling chambers 62, 64 are closed by covers. That is, the discharge sound-muffling chamber 62 is closed by an upper cover 66, and the discharge sound-muffling chamber is closed by a lower cover 68.

In this case, a bearing 54A is erected on a center of the upper supporting member 54, and a cylindrical bush 122 is mounted on the inner surface of the bearing 54A. A bearing 56A is formed through a center of the lower supporting member 56, and a cylindrical bush 123 is mounted on the inner surface of the bearing 56A. The bushes 122, 123 are made of later-described materials of high sliding characteristics. The rotary shaft 16 is held by the bearing 54A of the upper supporting member 54 and the bearing 56A of the lower supporting member 56 through the bushes 122, 123.

In this case, the lower cover 68 is made of a doughnut-shaped circular steel plate, four places of its peripheral portion are fixed to the lower supporting member 56 by main bolts 129 from the lower side, and the cover closes the lower opening of the discharge sound-muffling chamber 64 communicated with the inside of the lower cylinder 40 of the first rotary compression element 32 through a discharge port (not shown). A tip of each main bolt 129 is engaged with the upper supporting member 54.

The inner peripheral edge of the lower cover 68 is projected inward from the inner surface of the bearing 56A of the lower supporting member 56. Accordingly, the lower end surface of the bush 123 is held by the lower cover 68, whereby its falling-off is prevented. The discharge sound-muffling chamber 64 and the inside of the airtight chamber 12 are communicated with each other through a communication path which penetrates the upper and lower cylinders 38, 40 and the middle partition plate 36. A discharge pipe 121 is erected on the upper end of the communication path. A middle-pressure refrigerant compressed by the first rotary compression element 32 is discharged from the middle discharge pile 121 into the airtight container 12.

The upper cover 66 closes the upper opening of the discharge sound-muffling chamber 62 communicated with the inside of the upper cylinder 38 of the second rotary compression element 34 through a discharge port 39, and divides the inside of the airtight container 12 into the discharge sound-muffling chamber 62 side and the electric element 14 side. The upper cover 66 is made of a roughly doughnut-shaped circular steel plate in which a hole is formed to insert the bearing 54A of the upper supporting member 54 through, and its peripheral portion is fixed to the upper supporting member 54 from above by four main bolts 78. A tip of each main bolt 78 is engaged with the lower supporting member 56.

In the middle partition plate 36 which closes the lower opening surface of the upper cylinder 38 and the upper opening surface of the lower cylinder 40, a through-hole 131 is bored in a position corresponding to a suction side in the upper cylinder 38 to constitute an oil supply path by communicating the outer peripheral surface with the inner peripheral surface. An opening on the outer peripheral surface side of the through-hole 131 is sealed by a pressed-in sealing material 132. A communication hole 133 is bored on the middle part of the through-hole 131 to be extended upward.

On the other hand, a communication hole 134 is bored in a suction port 161 (suction side) of the upper cylinder 38 to be communicated with the communication hole 133 of the middle partition plate 36. Horizontal-direction oil supply holes 82, 84 are formed in the rotary shaft 16 (also formed in the upper and lower eccentric sections 42, 44 of the rotary shaft 16) to be communicated with an oil hole formed vertically around an axis. An opening of the inner peripheral surface side of the through-hole 131 of the middle partition plate 36 is communicated through these oil supply holes 82, 84 with the oil hole.

As the inside of the airtight container 12 is se to middle pressure as described later, supplying of oil into the upper cylinder 38 which is set to high pressure at the second stage. However, because of the aforementioned constitution of the middle partition plate 36, oil scooped up from the oil reservoir on the bottom in the airtight container 12 is raised through the oil hole. The oil discharged out of the oil supply holes 82, 84 enters the through-hole 131 of the middle partition plate 36, and the oil is supplied through the communication holes 133, 134 to the suction side (suction port 161) of the upper cylinder 38.

On the other hand, in the upper cylinder 38, a guide groove 70 is formed to contain the vane 50, and a housing section 70A is formed outside the guide groove 70 to contain a spring member (spring) 76. The spring 76 is abutted on the outside end of the vane 50 to always press the vane 50 to the roller 46 side. A metal plug 137 is disposed in the housing section 70A in the airtight container 12 side of the spring 76 to prevent pulling-out of the spring 76.

On the side face of the container main body 12A of the airtight container 12, sleeves 141, 142, 143 and 144 are welded and fixed to positions corresponding to the suction paths 58, 60 of the upper and lower supporting members 54 and 56, the discharge sound-muffling chamber 62 and the upper side of the upper cover 66 (position roughly corresponding to the lower end of the electric element 14). The sleeves 141 and 142 are adjacent to each other up and down, and the sleeve 143 is roughly on a diagonal line of the sleeve 141. The sleeve 144 is in a position shifted from the sleeve 141 by roughly 90°.

An end of a refrigerant introduction pipe 92 is inserted and connected in the sleeve 141 to introduce refrigerant gas into the upper cylinder 38, and communicated with the suction path 58 of the upper cylinder 38. The refrigerant introduction pipe 92 passes through the upper side of the airtight container 12 to reach the sleeve 144, and the other end is inserted and connected in the sleeve 144 to be connected with the inside of the airtight container 12.

An end of a refrigerant introduction pipe 94 is inserted and connected in the sleeve 142 to introduce refrigerant gas into the lower cylinder 40, and communicated with the suction path 60 of the lower cylinder 40. The other end of the refrigerant introduction pipe 94 is connected through an accumulator (not shown) to the evaporator 157. Additionally, a refrigerant discharge pipe 96 is inserted and connected in the sleeve 143, and an end of the refrigerant discharge pipe 96 is communicated with the discharge sound-muffling chamber 62.

Around the outer surfaces of the sleeves 141, 143, 144, flanges 151 are formed to be engaged with couplers for pipe connection, and a thread groove 152 for pipe connection is formed on the inner surface of the sleeve 142. Thus, when an airtight test is carried out in completion inspection of the manufacturing process of the rotary compressor 10, the couplers of test pipes can be easily connected to the flanges 151 in the sleeves 141, 143, 144, and the test pipe can be easily screw-fixed by using the thread groove 152 in the sleeve 142.

The rotary compressor 10 disposed in the drier 100 of the embodiment constitutes a refrigerant circuit similar to that shown in FIG. 4, in which a high pressure side of a vapor compression cycle is run at supercritical pressure. That is, the refrigerant discharge pipe 96 of the rotary compressor 10 is connected to an inlet of the gas cooler 154 which heat air to be blown into the drying chamber 108. This gas cooler 154 is disposed in the outlet of the air circulation path 112 as described above. A pipe out of the gas cooler 154 is passed through the expansion valve 156 as the pressure reducing device to reach the inlet of the evaporator 157, and the outlet of the evaporator 157 is connected to the refrigerant introduction pipe 94.

Next, an operation in the foregoing constitution will be described. A predetermined amount of an article 116 to be dried is contained in the drying chamber 108 (in the rotary drum 110). A control device is disposed in the machine chamber 104 to control the drier 100. The control device controls a temperature of the gas cooler 154 to prevent discoloring, damaging or the like of the article 116 contained in the drying chamber 108, and a temperature of the evaporator 157 to prevent frost generation. When power is supplied to the stator coil 28 of the electric element 14 through the terminal 20 and a not-shown wiring, the rotary drum 110 is rotated, and the electric element 14 is actuated to rotate the rotor 24. By this rotation, the upper and lower rollers 46, 48 fitted to the upper and lower eccentric sections 42, 44 integrally disposed with the rotary shaft 16 are eccentrically rotated in the upper and lower cylinders 38, 40.

Accordingly, low-pressure refrigerant gas sucked from the suction port 162 to the low-pressure chamber side of the lower cylinder 40 through the refrigerant introduction pipe 94 and the suction path 60 formed in the lower supporting member 56 is compressed by the roller 48 and a vane operation to become middle pressure, passed from the high-pressure chamber side of the lower cylinder 40 to the discharge port, passed from the discharge sound-muffling chamber 64 formed in the lower supporting member 56 to the communication path, and discharged through the middle discharge pipe 121 into the airtight container 12. Thus, middle pressure is set in the airtight container 12.

Then, the middle-pressure refrigerant gas in the airtight container 12 is taken out from the sleeve 144, passed through the refrigerant introduction pipe 92 and the suction path 58 formed in the upper supporting member 54, and sucked from the suction port 161 to the low-pressure chamber side of the upper cylinder 38. The sucked middle-pressure refrigerant gas is subjected to compression of the second stage by the operations of the roller 46 and the vane 50 to become refrigerant gas of a high temperature and high pressure. It is passed from the high-pressure chamber side through the discharge port 39, and supplied through the discharge sound-muffling chamber 62 formed in the upper supporting member 54 and the refrigerant discharge pipe 96 into the gas cooler 154.

At the gas cooler 154, the refrigerant is heat-exchanged with air in the air circulation path 112 to be cooled, and then it is discharged from the gas cooler 154. Then, a supercritical cycle is repeated in which after pressure is reduced by the expansion valve 156, the refrigerant flows into the evaporator 157 to be evaporated, and it is sucked from the refrigerant introduction pipe 94 into the first rotary compression element 32. A temperature of the refrigerant when it is introduced is raised to about +90° C. to +100° C. This refrigerant gas of the high temperature and the high pressure radiates heat at the gas cooler 154, and air heated by this radiated heat to become a high temperature is blown into the drying chamber 108 by the blower 114.

The air blown into the drying chamber 108 warms the wet article 116 contained in the rotary drum 110 to evaporate moisture, whereby the article 116 is dried. The air which has dried the article 116 and contains moisture is sucked from the inlet 112A of the air circulation path 112 into the same. The evaporator 157 is disposed in the inlet 112A of the air circulation path 112. Since a temperature of the evaporation 157 is lowered to about +3° C., the air containing moisture is condensed on the surface in the process of being passed through the evaporator 157 to become water droplets and fall. The fallen water droplets are discharged through the drain pipe 158 to the drain ditch.

The air dried by removing the moisture at the evaporator 157 is blown to the outlet side of the air circulation path 112 by the blower 114. A cycle is repeated in which since the gas cooler 154 is disposed on the outlet side of the air circulation path 112, the dried air is heated again by the gas cooler 154, and blown into the drying chamber 108, and the moisture of the article 116 in the drying chamber 108 is removed to dry the article. This cycle is repeated by the control device for a predetermined time, whereby the article 116 in the drying chamber 108 can be completely dried.

Thus, since the drier 100 comprises the refrigerant circuit constituted by sequentially installing and connecting the rotary compressor 10, the gas cooler 154, the expansion valve 156 and the evaporator 157 in the annular shape, and the blower 1 which circulates air of the drying chamber 108 to exchange heat with the gas cooler 154 and the evaporator 157, the moisture contained in the air which dries the article 116 contained in the drying chamber 108 can be condensed by the evaporator to be discarded from the drain pipe 158. Therefore, it is possible to greatly increase energy efficiency of the drier 100.

Since the article 116 can be quickly dried within a very short time, it is possible to greatly shorten the running time of the drier 100.

Furthermore, since the CO₂ refrigerant is sealed in the refrigerant circuit, the temperature of the gas cooler 154 can be set very high as described above. Thus, an increase rate of the temperature of the air circulated in the drying chamber 108 can be enhanced to enable drying of the article 116 contained in the drying chamber 108 within a short time.

(Second Embodiment)

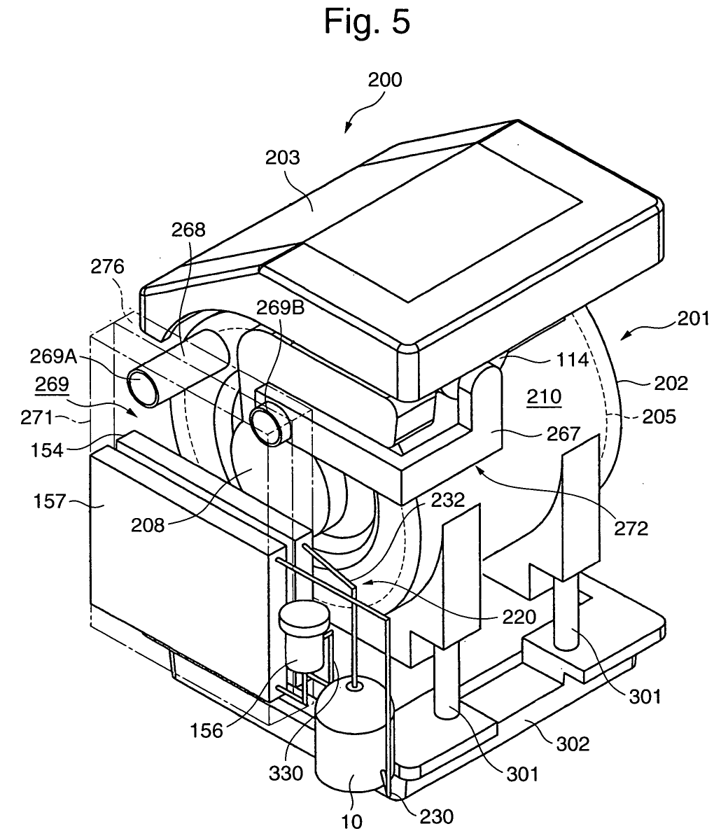

FIG. 5 is an internal constitutional view of a washing drier 200 which executes washing running and drying running after the end of the washing running as another embodiment of a drier to which the present invention is applied. According to the embodiment, the washing drier 200 is used to wash and dry a laundry such as clothes (this laundry becomes an article to be dried during drying running). An opening/closing door 203 is attached to the upper surface center of a main body 201 (FIG. 5 shows the inside of a case of the main body 201) which constitutes an outer shell. On the upper surface of the main body 201 of the opening/closing door 203 side, a not-shown operation panel is disposed in which various operation switches and a display section are arranged.

In the main body 201, a cylindrical outer tank drum 202 made of a resin is disposed to store water. This outer tank drum 202 is arranged such that a cylindrical shaft is in a left-and-right direction. In the outer tank drum 202, a cylindrical stainless inner tank drum (rotary drum according to the invention) 205 is disposed to serve as a washing tank and a dewatering tank. The inside of the inner tank drum 205 is set as a housing chamber (which functions as a drying chamber during drying running) 210 to contain the laundry. This drum is also arranged such that a cylindrical shaft is in a left-and-right direction. This shaft is connected to a shaft 208 of a not-shown driving motor mounted on the side wall (deep side of FIG. 5) of the outer tank drum 202, and the inner tank drum 205 is held so as to be rotated around the shaft 208 in the outer tank drum 202. Since vibration/displacement occurs by the rotation of the inner tank drum 205, the outer tank drum 202 is fixed to a base 302 positioned on the bottom surface of the main body 201 through a suspension 301 which has a vibration absorption function in order to reduce vibration/noise. That is, the rotary inner tank drum 205 is attached to the base 302 through the outer tank drum 202 and the suspension 301.

On the upper side of the outer tank drum 202, a not-shown watertight opening/closing cap is disposed to contain the laundry corresponding to the opening/closing door 203. A number of through-holes (not shown) are formed on a full peripheral wall of the inner tank drum 205 to enable distribution of air and water. A stop position of the inner tank drum 205 is defined, and a not-shown opening/closing cap is disposed to take in or out the laundry in a position (upper surface) corresponding to the opening/closing cap of the outer tank drum 202 at time of stoppage thereof.

The driving motor rotates the inner tank drum 205 around the shaft of the left-and-right horizontal direction during drying washing running and drying running after the end of the washing running. The driving motor is attached to one end (deep side of FIG. 5) of the shaft 208, and controlled by a not-shown control device to rotate the inner tank drum 205 at a speed lower compared with that of the washing running during the drying running.

A hollow portion hollow inside is formed in the other end (front side of FIG. 5) of the shaft 8 and, through this hollow portion, a later-described air circulation path 272 and the inside of the inner tank drum 205 are communicated with each other.

On the upper side of the main body 201, a not-shown water supply path is disposed as water supply means to supply water into the inner tank drum 205. An end of the water supply path is connected through a water supply valve to a water supply source such as tap water. Opening/closing of the water supply valve is controlled by the control device. The other end of the water supply path is connected to the outer tank drum 202 to be communicated with the inside. When the water supply valve is opened by the control device, water (tap water) is supplied from the water supply source to the housing chamber 210 in the inner tank drum 205 disposed in the outer tank drum 202.

On the lower side of the main body 201, a not-shown drain path is disposed as water discharging means to discharge water from the housing chamber 201 in the inner tank drum 205. An end of the drain path is communicated with the lowermost portion of the outer tank drum 202 through the drain valve controlled to be opened/closed by the control device. The other end of the drain path is lead out to the outside of the washing drier 200 to reach the drain ditch or the like.

On the other hand, in the washing drier 200, the air circulation path 272 is constituted from the rear side to the side of the outer tank drum 202 in the main body 201. This air circulation path 272 comprises a duct member 267 of a discharge side, a duct member 268 of a suction side, an air path 269 formed in a duct box 271, etc. An end of the duct member 267 is connected and fixed to the outer tank drum 202 so as to be communicated with the inside (housing chamber 210) of the inner tank drum 205 through the hollow portion formed in the other end (front side of FIG. 5) of the shaft 208. The other end is connected and fixed to an outlet 269B of the air path 269 formed in the duct box 271. An end of the duct member 268 is connected and fixed to the outer tank drum 202 so as to be communicated with the inside (housing chamber 210) of the inner tank drum 205 in the outer tank drum 202, and the other end is connected and fixed to an inlet 269A of the air path 269.

Both duct members 267, 268 which constitute the air circulation path 272 are made of metals or heat resisting synthetic resins, and all or at least parts thereof are made of flexible materials, e.g., flexible hoses.

A blower 114 is disposed as blowing means similar to the foregoing in the duct member 267. The blower 114 blows and supplies air of the air circulation path 272 from the duct member 267 of the air circulation path 272 through the hollow portion of the shaft 208 to the housing chamber 272 in the inner tank drum 205. That is, the washing drier 200 circulates the air of the air circulation path 272 into the inner tank drum 205 by the blower 114 during drying running, and thereby discharges the air heated by heat exchange with a gas cooler 154 (radiator) similar to the foregoing, which is disposed in the air path 269 of the air circulation path 272, to the housing chamber 210 in the inner tank drum 205.

The air path 269 is formed in the duct box 271 as described above. As shown in FIG. 5, the inside of the duct box 271 is divided into a front side and a deep side by a heat insulating partition member 276 in a state in which lower portions thereof are communicated with each other. Accordingly, in the duct box 271, a series of the air path 269 is constituted in a detour form in which it is lowered from the upper side at the front side and then raised from the lower side at the deep side. Then, an evaporator 157, similar to the foregoing, of a refrigerant circuit 220 of this case is disposed on the front side of the air path 269, and the gas cooler 154 of the refrigerant circuit 220 is disposed on the deep side.

As described above, the lower sides of the gas cooler 154 and the evaporator 157 are not divided by the partition member 267 but communicated with each other. An inlet 269A of the air path 269 is opened in the upper side of the air path 269 on the front side of the duct box 271, whereby the duct member 268 is communicated with the upper side of the air path 269 on the front side of the duct box 271. An outlet 269B of the air path 269 is opened in the upper side of the air path 269 on the deep side of the duct box 271, whereby the duct member 267 is communicated with the upper side of the air path 269 on the deep side of the duct box 271.

Thus, the air which has been circulated in the housing chamber 210 by running the blower 114 and dried the laundry is passed through the duct member 268 of the air circulation path 272 to flow from the inlet 269A into the air path 269 on the front side of the duct box 271. It is then lowered to exchange heat with the evaporator 157 disposed in the air path 269 on the front side to be cooled. After dehumidified, the air enters the air path 269 on the deep side of the duct box 271 from the lower side of the partition member 276. It is then raised to exchange heat with the gas cooler 154 disposed in the air path 269 on the deep side to be heated. Then, the air is discharged from the outlet 269B to enter the duct member 267, sucked by the blower 114 disposed therein, and discharged from the blower 114 into the housing chamber 210.

A reference numeral 220 denotes the refrigerant circuit. The refrigerant circuit 220 is constituted by sequentially installing and connecting the rotary compressor 10 similar to the foregoing, the gas cooler 154, an expansion valve 156 as a pressure reducing device similar to the foregoing, the evaporator 157, etc. The duct box 271 which incorporates the rotary compressor 10, the expansion valve 156, the gas cooler 154 and the evaporator 157 is attached to a base 302 to be fixed. A predetermined amount of carbon dioxide (CO₂) is sealed as a refrigerant in the refrigerant circuit 220.

In this case, a low-pressure refrigerant is introduced from a refrigerant introduction pipe 230 into a rotary compression element 32 of the rotary compressor 10, and a refrigerant of a high temperature and high pressure compressed by a second rotary compression element is discharged from a refrigerant discharge pipe 232 to the outside of the rotary compressor.

The refrigerant discharge pipe 232 of the rotary compressor 10 of the refrigerant circuit 220 is connected to an inlet of the gas cooler 154 for heating air. A pipe 330 out of the gas cooler 154 is connected to an inlet of the expansion valve 156, a pipe out of the expansion valve 156 reaches an inlet of the evaporator 157, and a pipe out of the evaporator 157 is connected to the refrigerant introduction pipe 230 to reach the rotary compressor 10. Running of the rotary compressor 10 and the expansion valve 156 are controlled by the control device.

The control device is control means for controlling the washing drier 200, and controls running of a not-shown driving motor, opening/closing of a water supply valve of a water supply path, opening/closing of a drain valve of a drain path, running of the rotary compressor 10, diaphragm adjustment of the expansion valve 156, and the blowing amount of the blower 114. Further, the control device controls a temperature of air passed through the gas cooler 154 to prevent discoloring or damaging of the laundry contained in the inner tank drum 205.

Next, an operation in the foregoing constitution will be described. When a laundry and a predetermined amount of a detergent are thrown in to a housing chamber 210 in the inner tank drum 205, and a power source switch and a start switch among the operation switches are operated, the control device starts washing running. Then, the control device opens a water supply valve of a not-shown water supply path to open it. Accordingly, water is supplied from the water supply source into the housing chamber 210 of the inner tank drum 205 in the outer tank drum 202. At this time, the drain valve of the drain path is closed by the control device.

When a predetermined amount of wager is stored in the housing chamber 210 in the inner tank drum 205, the control device closes the water supply valve to close the water supply path. Thus, the supplying of water from the water supply source is stopped.

Then, the control device supplies power and starts the driving motor formed on the side face of the main body 201 to rotate the shaft 208, whereby the inner tank drum 205 attached to the shaft 208 starts to rotate in the outer tank drum 202, and washing step of the washing running is started.

After the passage of predetermined time from the start of the washing step, the control device stops the driving motor, and opens the drain valve of the drain path to discharge the water (washing water) from the housing chamber 210 of the inner tank drum 202 (i.e., outer tank drum 205).

After the water has been discharged from the housing chamber 210 of the inner tank drum 205, the control device actuates the driving motor again to dehydrate the laundry. After this dehydration is carried out for a predetermined time, the control device closes the drain valve of the drain path.

Then, the control device proceeds to a rinsing step, where the water supply valve of the water supply path is opened to open the water supply path. Thus, water is supplied again from the water supply source into the housing chamber 210 of the inner tank drum 205.

When a predetermined amount of water is supplied into the housing chamber 210 of the inner tank drum 205, the control device closes the water supply valve to close the water supply path. Accordingly, the supplying of water from the water supply source is stopped.

After the driving motor has been repeatedly rotated for a predetermined time to execute rinsing, the control device stops the driving motor, and opens the drain valve of the drain path to discharge the rinsing water from the housing chamber 210 to the drain path. After the discharging of the rinsing water from the housing chamber 210, the control device actuates the driving motor again to rotate the inner tank drum 205 as in the previous case, and then proceeds to a dehydration step, where the laundry is dehydrated.

After the dehydration step has been executed for a predetermined time, the control device closes the drain valve. The control device actuates the rotary compressor 10, and starts running of the blower 114. Then, the inner tank drum 205 is rotated by the driving motor to start drying running. During the drying running, a cycle is executed in which refrigerant gas of a high temperature and high pressure discharged from the rotary compressor 10 radiates heat at the gas cooler 154, pressure is reduced by the expansion valve 156, and then the refrigerant flows into the evaporator 157 to absorb heat from the surroundings, and evaporated to be sucked from the refrigerant introduction pipe 232 into the first rotary compression element 32 of the rotary compressor 10.

By running the blower 114, air heated by the heat radiated from the refrigerant of the high temperature and the high pressure at the gas cooler 154 to become a high temperature exits from the duct member 267 of the air circulation path 272 to be discharged into the housing chamber 210 of the inner tank drum 205.

The heated air discharged from the housing chamber 210 warms the laundry contained in the inner tank drum 205 (housing chamber 210) to evaporate moisture, whereby the laundry (article to be dried) is dried. The air which has dried the laundry and contains moisture is passed through the housing chamber 210, passed through a not-shown through-hole to exit from the inner tank drum 205, passed through the duct member 268 of the air circulation path 272 to be sucked from the inlet 269A into the air path 269, and introduced to the evaporator 157 disposed therein to be passed.

The moisture (moisture evaporated from the laundry) contained in the air from the housing chamber 210 is condensed on the surface of the evaporator 157 in the process of being passed through the evaporator 157 to become water droplets and fall. The fallen water droplets are discharged from the drain path through a not-shown drain pipe to the external drain ditch or the like.

The air which has been dried by the moisture removal at the evaporator 157 then flows into the gas cooler 154 to be heated. Then, a cycle is repeated in which the air exits from the outlet 269B of the air path 269 to enter the duct member 267, sucked by the blower 114 to be blown to the hollow portion side of the shaft 208, and discharged to the housing chamber 210 in the inner tank drum 205 to remove moisture from the laundry in the inner tank drum 105, and to dry it.

By execution of such drying running at the control device for a predetermined time, the laundry in the housing chamber 210 of the inner tank drum 205 is completely dried. Thus, it is possible to efficiently dry the laundry by heating the air in the air circulation path 272 at the gas cooler 154 and dehumidifying it at the evaporator 157. Moreover, by using the refrigerant such as carbon dioxide in which the high pressure side of the refrigerant circuit becomes supercritical pressure, it is possible to obtain a large heating ability at the gas cooler 154.

The rotation of the inner tank drum 205 causes vibration and displacement in the outer tank drum 202 and the inner tank drum 205. However, such vibration and displacement are absorbed by a suspension 301. Thus, vibration transmitted to the base 302 is softened to reduce noise.

On the other hand, the vibration/displacement of the inner tank drum 205 and the outer tank drum 202 causes shifting in the positions of the duct box 271 and the outer tank drum 202 attached to the base 302. Consequently, positional relations between ends and the other ends of the duct members 267, 268 are changed. However, since the duct members 267a and 268 are flexible, even when the inner tank drum 205 and the outer tank drum are vibrated or displaced by rotation, the duct members 267, 268 can absorb the vibration or displacement themselves. Thus, it is possible to prevent a problem of damaging in the connection places of the duct members 267, 268 to the duct box 271 and the outer tank drum 202.

According to the embodiment, the rotary compressor of the internal middle pressure multistage (two stages) compression type which comprises the first and second rotary compression elements 32, 34 is used. However, a compressor to be used for the present invention is not limited to this.

As discussed in detail above, according to the present invention, since the drier which comprises the drying chamber to hose the article to be dried comprises the refrigerant circuit constituted by sequentially installing and connecting the compressor, the gas cooler, the pressure reducing device and the evaporator in the annular shape, and the blowing means which circulates air of the drying chamber to exchange heat with the gas cooler and the evaporator, the article contained in the drying chamber is heated by the high-temperature air heated by the gas cooler, and the moisture evaporated from the article can be condensed by the evaporator to be discarded.

Therefore, it is possible to shorten time necessary for drying, and to greatly increase energy efficiency.

Since discharging to the outside of the drying chamber is not necessary to discharge moisture, an environment in the room in which the drier is installed is not deteriorated, and it is possible to remove equipment costs for in-room environment improvement.

Since the CO₂ refrigerant is sealed in the refrigerant circuit, the temperature of the gas cooler can be set very high as described above. Thus, by maintaining a high temperature of the air circulated in the drying chamber and drying the article contained in the drying chamber within a short time, it is possible to further reduce the consumption of energy used for drying.

Furthermore, since the rotary drum is disposed which is attached to the base through the suspension for vibration absorption, and in which the drying chamber is constituted inside, components constituting the refrigerant circuit are attached to the base, and the duct member which supplies the air heat-exchanged with the gas cooler and introduces the air passed through the drying chamber into the evaporator is flexible, even when the rotary drum is vibrated or displaced with respect to the base by rotation, since the duct member can absorb the vibration or displacement itself, it is possible to prevent a problem of damaging in the connection place of the duct member.

What is claimed is:

1. A drier which is equipped with a drying chamber for containing an article to be dried, comprising:
a refrigerant circuit constituted by sequentially installing and connecting a compressor, a gas cooler, a pressure reducing device and an evaporator in an annular shape; and
blowing means for circulating air in the drying chamber to exchange heat with the gas cooler and the evaporator.

2. The drier according to claim 1, wherein a CO₂ refrigerant is sealed in the refrigerant circuit.

3. The drier according to claim 1 or 2, further comprising a rotary drum which is attached to a base through a suspension for vibration absorption and in which the drying chamber is installed,
wherein components constituting the refrigerant circuit are attached to the base, the air heat-exchanged with the gas cooler is supplied into the drying chamber, and a duct member for introducing the air passed through the drying chamber into the evaporator is flexible.
